(19) United States
(12) Patent Application Publication
(10) Pub. No.: US 2018/0174116 A1
(43) Pub. Date: Jun. 21, 2018

(54) METHOD AND SYSTEM FOR PROVIDING PAYMENT LINK IN DIGITAL CONVERSATIONS

(71) Applicant: Mastercard International Incorporated, Purchase, NY (US)

(72) Inventor: Pia MAENPAA, White Plains, NY (US)

(73) Assignee: Mastercard International Incorporated, Purchase, NY (US)

(21) Appl. No.: 15/386,493

(22) Filed: Dec. 21, 2016

(51) Int. Cl. G06Q 20/08; G06Q 20/10; G06F 17/30

(52) U.S. Cl. CPC G06Q 20/085; G06F 17/30882; G06Q 20/102

(57) ABSTRACT

A method for facilitating payment through an encoded link includes: displaying an interactable link in a first application program, wherein the interactable link refers to a second application program and is encoded with at least transaction data; receiving a first user instruction from a user of the computing device representing interaction with the interactable link; transmitting, at least the transaction data to the second application program; displaying at least one of: the transaction data and data associated with the transaction data in the second application program; receiving a second user instruction from the user of the computing device indicating confirmation of payment credentials; and transmitting at least the transaction data and confirmation of payment credentials.

### FIELD

The present disclosure relates to the facilitation of payments through encoded links, specifically the inclusion of an encoded link in a digital conversation to enable the initiation of an electronic payment transaction without having to leave the digital conversation.

### BACKGROUND

When shopping at a physical location of a merchant that is staffed by employees, a consumer often has the opportunity to speak with employees to ask questions and receive assistance. A consumer could speak to an employee and, when ready to check out, would be helped by the same employee or directed to the proper location by the employee. Traditionally, in e-commerce and other Internet-based payment transactions, the ability for a consumer to receive assistance is limited to item descriptions that accompany a product and any support web pages provided by the merchant. As a result, it may be difficult for a consumer to get the assistance they need when shopping.

In an effort to provide greater customer service, some merchants have begun to utilize digital messaging platforms to enable consumers to speak with representatives of the merchant during their shopping experience. However, while such methods may be helpful in conveying information to a consumer, such methods often make initiating a payment transaction difficult for the consumer. For instance, the consumer must either navigate to and select the products they wish to purchase manually, or must provide their payment information directly to the representative, who may initiate the payment transaction themselves. In former instances, finding the product(s) may be difficult or time consuming to manage. In latter instances, the consumer must trust the representative with their sensitive data, which may be collected using a third party messaging platform, and may also be unable to see any of the details of the transaction until it is already processed.

Thus, there is a need for a technical solution whereby a payment transaction may be initiated through a digital conversation by the consumer actually involved in the transaction, but with transaction details provided by the other party in the conversation.

### SUMMARY

The present disclosure provides a description of systems and methods for facilitating payments in a digital conversation through an encoded payment link. A payment link is provided to a consumer during a digital conversation, which immediately directs the consumer to payment, negating the need for the consumer to navigate to a secondary web page or to supply their sensitive financial information to a representative. In addition, the payment link is encoded with transaction details for the transaction, such as including the products being purchased, such that the transaction may be initiated without the consumer having to select the products themselves, and yet still providing the consumer with the opportunity to verify the products being purchased prior to the transaction being initiated. Thus, the methods and systems discussed herein streamline the purchasing process through digital conversations, while still enabling a consumer to retain all control over the transaction itself.

A method for facilitating payment through an encoded link includes: displaying, by a display device interfaced with a computing device, an interactable link in a first application program, wherein the interactable link refers to a second application program and is encoded with at least transaction data; receiving, by an input device interfaced with the computing device, a first user instruction from a user of the computing device representing interaction with the interactable link; electronically transmitting, by a communication module of the computing device, at least the transaction data to the second application program; displaying, by the display device interfaced with the computing device, at least one of: the transaction data and data associated with the transaction data in the second application program; receiving, by the input device interfaced with the computing device, a second user instruction from the user of the computing device indicating confirmation of payment credentials; and electronically transmitting, by a transmitting device of the computing device, at least the transaction data and confirmation of payment credentials.

A system for facilitating payment through an encoded link includes: a transmitting device of a computing device; a display device interfaced with the computing device configured to display an interactable link in a first application program, wherein the interactable link refers to a second application program and is encoded with at least transaction data; an input device interfaced with the computing device configured to receive a first user instruction from a user of the computing device representing interaction with the interactable link; and a communication module of the computing device configured to electronically transmit at least the transaction data to the second application program, wherein the display device interfaced with the computing device is further configured to display at least one of: the transaction data and data associated with the transaction data in the second application program, the input device interfaced with the computing device is further configured to receive a second user instruction from the user of the computing device indicating confirmation of payment credentials, and the transmitting device of the computing device is configured to electronically transmit at least the transaction data and confirmation of payment credentials.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the facilitating of payment transactions through encoded links in digital conversations in accordance with exemplary embodiments.

FIG. 2 is a block diagram illustrating the computing device of the system of FIG. 1 for facilitating payment transactions via encoded links in digital conversations in accordance with exemplary embodiments.

FIGS. 3A and 3B are a flow diagram illustrating a process for the initiation of a payment transaction through an encoded link using the system of FIG. 1 in accordance with exemplary embodiments.

FIG. 4 is a diagram illustrating a graphical user interface of the computing device of FIG. 2 for the initiation of a payment transaction through an encoded link in a digital conversation in accordance with exemplary embodiments.

FIG. 5 is a flow chart illustrating an exemplary method for facilitating payment through an encoded link in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Facilitating Payment Through Encoded Links in Digital Conversation

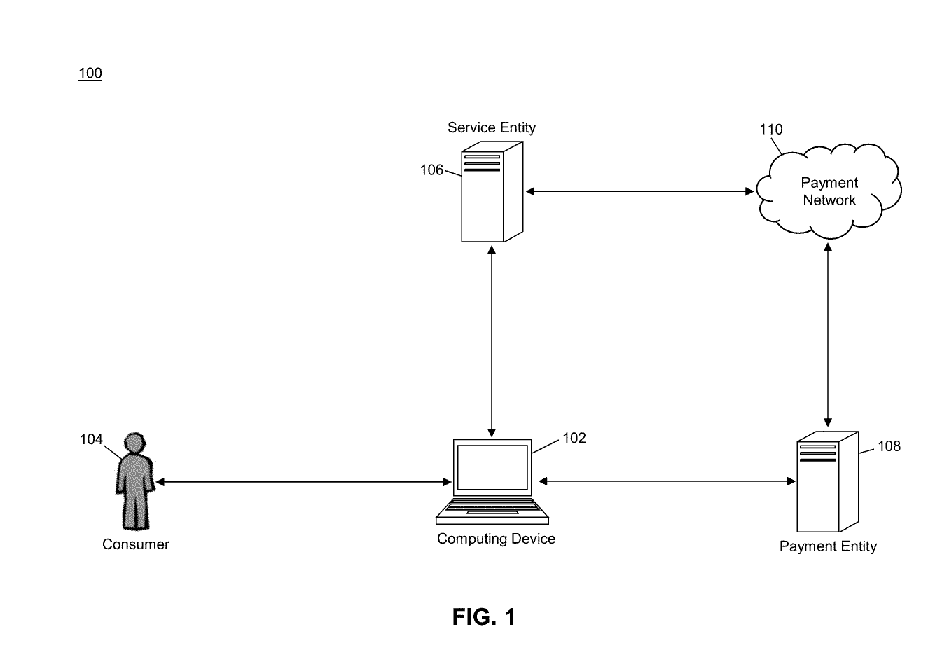

FIG. 1 illustrates a system 100 for the facilitation of electronic payment transactions via the use of encoded links provided during a digital conversation.

The system 100 may include a computing device 102. The computing device 102, discussed in more detail below, may be a specifically configured computing device that is configured to receive and display encoded links that, when interacted with by a user of the computing device 102, enable the user to initiate a payment transaction associated therewith directly from the computing device 102. The computing device 102 may be any type of computing device that may be specifically configured to perform the functions discussed herein, including being configured to execute digital messaging and conversation application programs and digital payment application programs, such as a specifically configured desktop computer, laptop computer, notebook computer, tablet computer, cellular phone, smart phone, smart watch, smart television, wearable computing device, implantable computing device, etc.

In the system 100, a consumer 104 may use the computing device 102 to participate in a digital conversation. The digital conversation may be facilitated via the use of a messaging application stored in or accessed by the computing device 102 (e.g., via cloud computing techniques) and executed thereby, to enable the consumer 104 to conduct a digital conversation with a representative of a merchant with whom the consumer 104 is interested in transacting. In some instances, the representative may be a live person with whom the consumer 104 is conversing. In other instances, the representative may be a computer program programmed to act as a representative, referred to herein as a “bot” or “chatbot.” As discussed herein, a messaging application configured to facilitate an ongoing conversation between the consumer 104 and another entity (e.g., a live person or simulated representative) may be referred to as a “live” messaging application.

For the conducting of the digital conversation, the computing device 102 may exchange data messages with a service entity 106. The service entity 106 may be the merchant or an entity associated therewith, configured to receive and transmit conversation messages from the representative to the computing device 102 for display to the consumer 104. For example, the service entity 106 may be a chat provider, a social network provider, or other entity operating on behalf of the merchant for the conducting of digital conversations with potential customers. The computing device 102 and service entity 106 may be configured to exchange data messages that are superimposed or otherwise encoded with conversation messages using a suitable communication network and method. For instance, conversation messages may be exchanged using a cellular communication network, the Internet, local area network, etc., or a combination thereof. As discussed herein, a digital conversation between the consumer 104 and the representative may be comprised of the exchange of data messages between the service entity 106 and the computing device 102, such that a message “sent” by the consumer 104 entails the electronic transmission of a data message encoded with such message to the service entity 106 and the parsing thereof and display to the representative.

The consumer 104 may participate in a digital conversation with the representative regarding the purchase of one or more products (e.g., goods or services). As part of the conversation, the consumer 104 and representative may agree on various terms regarding the potential electronic transaction, such as the price of the product(s), product details, total transaction amount, shipping information, warranties, etc. The consumer 104 may convey an interest to participate in an electronic payment transaction for the purchase of the products. The representative may see the consumer's interest, and may generate transaction data for the potential electronic payment transaction. The transaction data may include data to be conveyed for use in the processing of the electronic payment transaction, including at least a transaction amount, currency type, acquirer information, merchant data (e.g., merchant identification number), and any other suitable data.

The service entity 106 may generate a payment link that is encoded with the transaction data or data associated therewith. For instance, in one embodiment, the payment link may be encoded with the transaction data (e.g., the transaction amount and merchant identification number). In another embodiment, a transaction identifier unique to the potential electronic payment transaction may be generated by the service entity 106, which may be encoded in the payment link. In some instances, the system 100 may include a third party entity, which may be configured to generate encoded payment links for use herein. In such instances, the service entity 106 may provide the transaction data to the third party entity, which may return the payment link encoded with a transaction identifier to the service entity 106. The payment link may then be communicated to the consumer 104 in the digital conversation.

The payment link may be a link to another application program stored in or accessed by the computing device 102 and executed thereby. In some embodiments, the application program may be an electronic wallet application program configured to store and transmit payment credentials for use in funding electronic payment transactions. In some cases, the consumer 104 may provide the representative with their desired payment method during the conversation, prior to the generation of the payment link. In such cases, the service entity 106 may generate the payment link to be a reference directed to an application program consistent with the desired payment method. For instance, the consumer 104 may say (e.g., in the digital conversation) that they want to pay with a branded credit card, and the payment link may, when interacted with on the computing device 102, result in execution of an electronic wallet application program associated with the branded credit card.

The second application program, also referred to herein as the payment application program, may be configured to initiate the payment transaction based on the transaction data encoded in the payment link. For example, interaction with the payment link may cause the encoded transaction data to be provided to the second application program as input upon execution, which may then be used by the second application program in a new electronic payment transaction initiated thereby. In cases where the payment link may be encoded with an identifier, the second application program may communicate with the service entity 106 (e.g., or third party entity, as applicable) to obtain the corresponding transaction data using the transaction identifier. The second application program may be configured to present the transaction data to the consumer 104 for confirmation. In such instances, the consumer 104 may be able to verify that the service entity 106 provided the correct transaction data prior to transacting. In some cases, the second application program may provide the ability for the consumer 104 to modify the transaction data (e.g., selected products, product quantities, shipping information, etc.). In some such cases, the second application program may electronically transmit the modifications to the service entity 106 for confirmation.

In some embodiments, the second application program may be configured to collect additional data from the consumer 104 prior to initiation of the payment transaction. For example, the consumer 104 may be prompted to supply account details for a transaction account to be used to fund the payment transaction, may be prompted to select from one or more saved transaction accounts, may be prompted to enter a personal identification number or other authentication data, etc. The second application program may then electronically transmit the transaction data (including any additional data input by the consumer 104, if applicable) to a payment entity 108. The transaction data may include the data supplied by the service entity 106 as well as payment credentials for a selected transaction account, either previously stored in the computing device 102 or supplied by the consumer 104. Payment credentials may include at least a primary account number and any other data necessary for the processing of an electronic payment transaction funded by the related transaction account. The payment entity 108 may be a financial institution or other suitable type of entity configured to generate and submit transaction messages for electronic payment transactions. In some embodiments, the payment entity 108 may be the entity associated with the second application program, such as the entity operating or otherwise associated with the electronic wallet application program, or an entity associated with the selected transaction account (e.g., the issuing financial institution).

The payment entity 108 may receive the transaction data and may generate and submit, or electronically transmit the transaction data to an associated intermediate entity (e.g., an acquiring institution, gateway processor, etc.) to generate and submit an authorization request for an electronic payment transaction to a payment network 110. In some embodiments, the service entity 106 and the payment entity 108 may be the same entity. The authorization request may be a type of transaction message, which may be a specially formatted transaction message formatted pursuant to one or more standards governing the exchange of financial transaction messages, such as the International Organization of Standardization's ISO 8583 or ISO 20022 standards. The authorization request may include the transaction data, including the data supplied by the service entity 106 and the payment credentials. The payment network 110 may then process the electronic payment transaction using traditional methods and systems.

In some embodiments, the service entity 106 may be notified of the successful processing of the electronic payment transaction. In some cases, the payment network 110 may notify the service entity 106, such as by the transmission of an authorization response thereto. In other cases, the payment entity 108 may notify the service entity 106 of the processing, either directly (e.g., via a data message directly transmitted from the payment entity 108 to the service entity 106) or through the computing device 102 (e.g., the second application program may receive the indication of successful processing, and may instruct the first application program to notify the service entity 106 either directly or through the digital conversation).

The methods and systems discussed herein enable a consumer 104 to initiate an electronic payment transaction through a digital conversation, while still enabling a merchant or related entity (e.g., the service entity 106) to supply the transaction data. The supplying of the transaction data may provide for convenience to the consumer 104, while retaining the ability for the consumer 104 to review the transaction data prior to participating in the payment transaction as they are the party to initiate the transaction. In addition, the use of a payment link encoded with the transaction data that directs the consumer 104 to an appropriate payment application also ensures that the consumer 104 does not need to trust the service entity 106 with sensitive financial information. Furthermore, it also provides the ability for a service entity 106 to be a party to a payment transaction without requiring resources configured to initiate and process payment transactions themselves. As a result, the methods and systems discussed herein may provide significant improvements to efficiency and accountability for both consumers 104 and service entities 106 in the conducting of electronic payment transactions.

### Computing Device

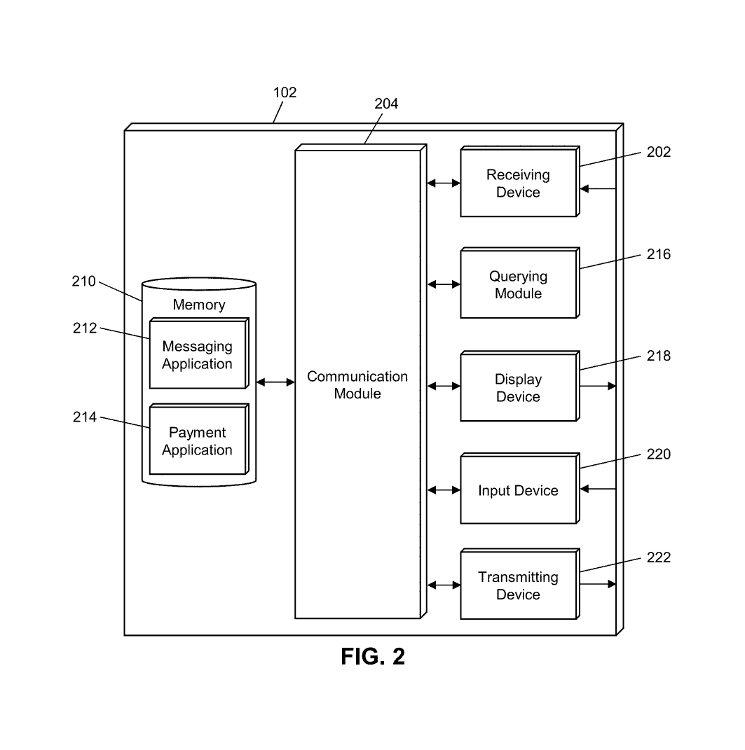

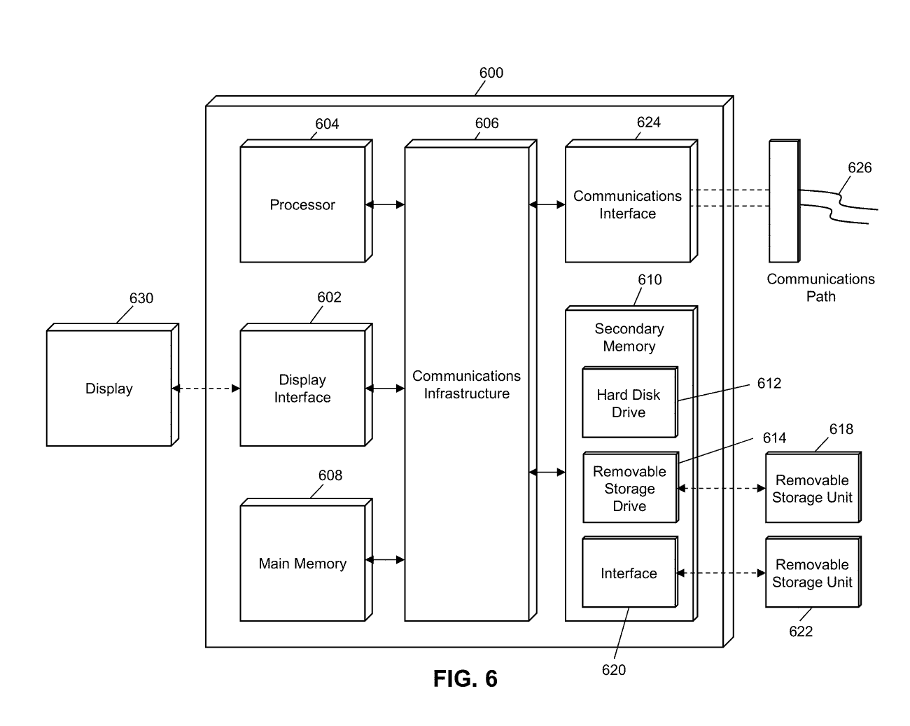

FIG. 2 illustrates an embodiment of a computing device 102 in the system 100. It will be apparent to persons having skill in the relevant art that the embodiment of the computing device 102 illustrated in FIG. 2 is provided as illustration only and may not be exhaustive to all possible configurations of the computing device 102 suitable for performing the functions as discussed herein. For example, the computer system 600 illustrated in FIG. 6 and discussed in more detail below may be a suitable configuration of the computing device 102.

The computing device 102 may include a receiving device 202. The receiving device 202 may be configured to receive data over one or more networks via one or more network protocols. In some instances, the receiving device 202 may be configured to receive data from service entities 106, payment entities 108, and other systems and entities via one or more communication methods, such as near field communication, physical contact points, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by service entities 106, which may be superimposed or otherwise encoded with messages as part of a digital conversation, or with transaction data requested following interaction with an encoded payment link. In some cases, a data message may include a payment link encoded with transaction data for a proposed electronic transaction, which may be initiated in the computing device 102. The receiving device 202 may also be configured to receive data signals electronically transmitted by payment entities 108, which may be superimposed or otherwise encoded with data associated with a processed electronic payment transaction. In some embodiments, the receiving device 202 may be configured to receive data signals electronically transmitted by third party entities that are superimposed or otherwise encoded with additional transaction data for a proposed electronic payment transaction.

The computing device 102 may also include a communication module 204. The communication module 204 may be configured to transmit data between modules, engines, databases, memories, and other components of the computing device 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing device 102 and external components of the computing device 102, such as externally connected databases, display devices, input devices, etc. The computing device 102 may also include a processing device. The processing device may be configured to perform the functions of the computing device 102 discussed herein as will be apparent to persons having skill in the relevant art. In some embodiments, the processing device may include and/or be comprised of a plurality of engines and/or modules specially configured to perform one or more functions of the processing device, such as a querying module 214. As used herein, the term “module” may be software or hardware particularly programmed to receive an input, perform one or more processes using the input, and provides an output. The input, output, and processes performed by various modules will be apparent to one skilled in the art based upon the present disclosure.

The computing device 102 may also include a memory 210. The memory 210 may be configured to store data for use by the computing device 102 in performing the functions discussed herein, such as public and private keys, symmetric keys, etc. The memory 210 may be configured to store data using suitable data formatting methods and schema and may be any suitable type of memory, such as read-only memory, random access memory, etc. The memory 210 may include, for example, encryption keys and algorithms, communication protocols and standards, data formatting standards and protocols, program code for modules and application programs of the processing device, and other data that may be suitable for use by the computing device 102 in the performance of the functions disclosed herein as will be apparent to persons having skill in the relevant art. In some embodiments, the memory 210 may be comprised of or may otherwise include a relational database that utilizes structured query language for the storage, identification, modifying, updating, accessing, etc. of structured data sets stored therein.

The memory 210 may be configured to store program data for a messaging application 212 and a payment application 214. In some embodiments, the program data may include program code executable by the computing device 102 for execution of the associated program. In other embodiments, the program data may include data suitable for use in identifying the application program stored on a remote computing system for execution by the computing device 102, such as may be accessible via cloud computing techniques. The messaging application 212 may be an application program configured to enable the consumer 104 as a user of the computing device 102 to conduct a digital conversation with a representative of a merchant via the service entity 106. In some embodiments, the messaging application 212 may be a part of a larger application program, such as a social network application program or an operating system of the computing device 102. The payment application 214 may be configured to initiate electronic payment transactions, such as via the transmission of transaction data and an indication of payment credentials to a payment entity 108. In some instances, the payment application 214 may be configured to store or receive payment credentials. In other instances, payment credentials may be accessed remotely, and may be identified via the payment application 214. In some such instances, the payment application 214 may be configured to provide authentication credentials to prove authorization for access to the payment credentials.

The computing device 102 may include a querying module 214. The querying module 214 may be configured to execute queries on databases to identify information. The querying module 214 may receive one or more data values or query strings, and may execute a query string based thereon on an indicated database, such as the memory, to identify information stored therein. The querying module 214 may then output the identified information to an appropriate engine or module of the computing device 102 as necessary. The querying module 214 may, for example, execute a query on the memory 210 to identify program code associated with the messaging application 212 or payment application 214 for execution in performing the functions discussed herein, for instance the identification of program code associated with a payment application 214 based on an encoded payment link.

The computing device 102 may also include or be otherwise interfaced with one or more input devices 220. The input devices 220 may be internal to the computing device 102 or external to the computing device 102 and connected thereto via one or more connections (e.g., wired or wireless) for the transmission of data to and/or from. The input devices 220 may be configured to receive input from a user of the computing device 102, such as the consumer 104, which may be provided to another module or engine of the computing device 102 (e.g., via the communication module 204) for processing accordingly. Input devices 220 may include any type of input device suitable for receiving input for the performing of the functions discussed herein, such as a keyboard, mouse, click wheel, scroll wheel, microphone, touch screen, track pad, camera, optical imager, etc. The input device 220 may be configured to, for example, receive conversation messages input from the consumer 104 as part of a digital conversation with a representative of the service entity 106, as well as additional data that may be input in response to a prompt from the payment application 214 for an electronic payment transaction being initiated.

The computing device 102 may also include or be otherwise interfaced with a display device 218. The display device 218 may be internal to the computing device 102 or external to the computing device 102 and connected thereto via one or more connections (e.g., wired or wireless) for the transmission of data to and/or from. The display device 218 may be configured to display data to a user of the computing device 102, such as the consumer 104. The display device 218 may be any type of display suitable for displaying data as part of the functions discussed herein, such as a liquid crystal display, light emitting diode display, thin film transistor display, capacitive touch display, cathode ray tube display, light projection display, etc. In some instances, the computing device 102 may include multiple display devices 218. The display device 218 may be configured to, for example, display conversation messages to the consumer 104 via the messaging application 212, as well as transaction data to the consumer 104 via the payment application 214 for confirmation for a proposed electronic transaction.

The computing device 102 may also include a transmitting device 222. The transmitting device 222 may be configured to transmit data over one or more networks via one or more network protocols. In some instances, the transmitting device 222 may be configured to transmit data to service entities 106, payment entities 108, and other entities via one or more communication methods, such as near field communication, physical contact points, Bluetooth, radio frequency, the Internet, etc. In some embodiments, the transmitting device 222 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that may be parsed by a receiving computing device. In some instances, the transmitting device 222 may include one or more modules for superimposing, encoding, or otherwise formatting data into data signals suitable for transmission.

The transmitting device 222 may be configured to electronically transmit data signals service entities 106 that are superimposed or otherwise encoded with data messages for a digital conversation between the consumer 104 and a representative. The transmitting device 222 may also be configured to electronically transmit data signals to payment entities 108, which may be superimposed or otherwise encoded with transaction data for submission to a payment network 110 as part of an electronic payment transaction initiated via the payment application 214. In some embodiments, the transmitting device 222 may also be configured to electronically transmit data signals to third party entities that are superimposed or otherwise encoded with requests for transaction data, which may include transaction identifiers identified via encoded payment links.

### Process for Initiating a Transaction Via an Encoded Payment Link

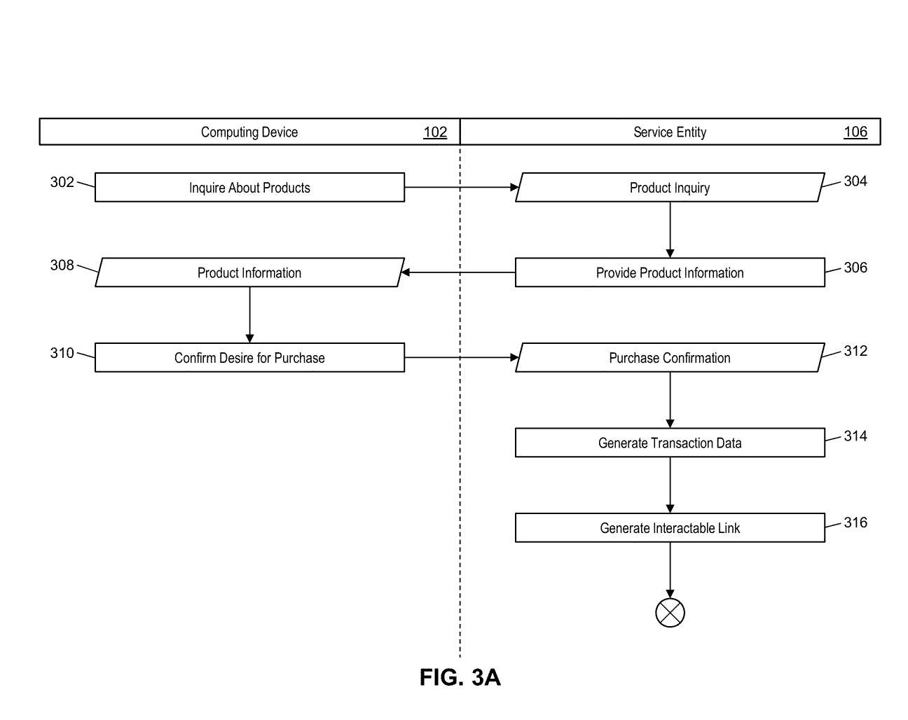

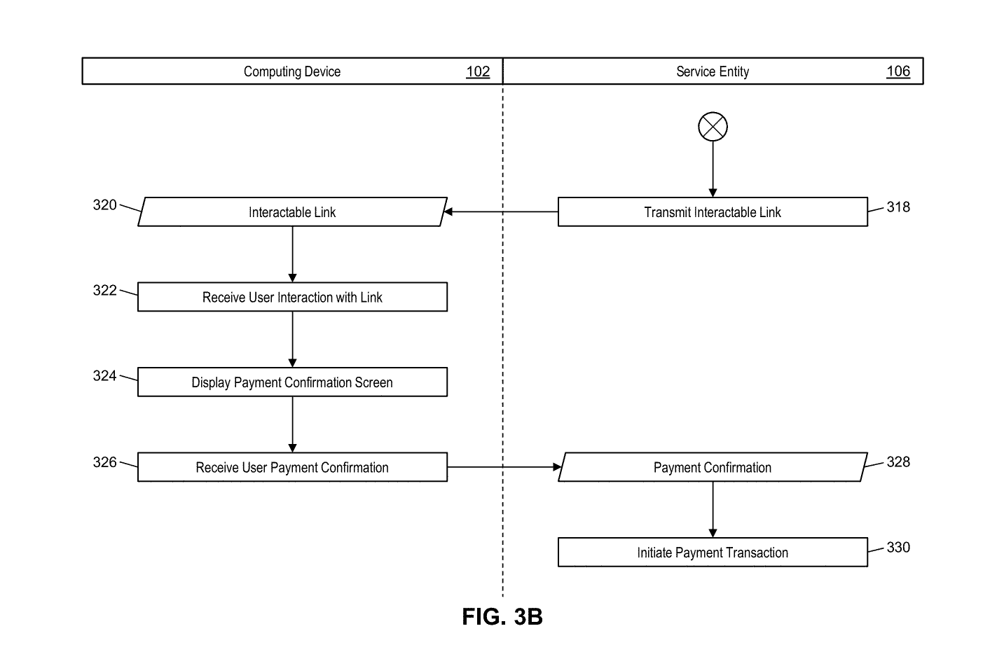

FIGS. 3A and 3B illustrate a process for the initiation of an electronic payment transaction by the computing device 102 in the system 100 via the use of an encoded payment link provided in a digital conversation from the service entity 106.

In step 302, the computing device 102 may electronically transmit a conversation message to the service entity 106 as part of a digital conversation. The conversation message may be comprised of an inquiry about products to be purchased that is submitted by the consumer 104 as part of the messaging application 212 via an input device 220 of the computing device 102. In step 304, the service entity 106 may receive the product inquiry, which may be used to identify one or more products available for purchase from a related merchant. In step 306, the service entity 106 may electronically transmit a conversation message back to the computing device 102 that includes product information for the identified products. Product information may include, for example, product costs, sizing information, product names, product images, etc.

In step 308, the receiving device 202 of the computing device 102 may receive the product information conversation message, which may be presented to the consumer 104 by a display device 218 of the computing device 102 via the messaging application 212. In step 310, the computing device 102 may electronically transmit a conversation message back to the service entity 106 that conveys the consumer's desire to purchase at least one particular product, where the consumer's desire may be identified via input received by the input device 220 that indicates accordingly. In step 312, the service entity 106 may receive the conversation message that includes the consumer's desire to purchase as confirmation to prepare the proposed electronic transaction. The purchase confirmation may also include an indication of the payment method desired by the consumer 104, which may correspond to a payment application 214 stored in or otherwise executable by the computing device 102.

In step 314, the service entity 106 may generate transaction data for the proposed electronic payment transaction. The generated transaction data may include any data necessary for the initiation of the electronic payment transaction by the payment application 214 of the computing device 102, such as a transaction amount, a merchant identification number associated with the seller of the identified product(s), acquiring institution information, etc. In step 316, the service entity 106 may generate an interactable link, which may be a reference identifier to the payment application 214 indicated by the consumer 104 through which the payment transaction may be initiated. The interactable link may also be encoded with data associated with the proposed electronic payment transaction, which may include the generated transaction data or a transaction identifier associated therewith. In some embodiments, step 316 may include the transmission of the transaction data to a third party entity and receipt of an interactable link therefrom. The interactable link may be a uniform resource locator or other type of pointer associated with the computing device 102 and may represented by interactable text, image, etc., such as a logo or other image associated with the payment application 214.

In step 318, the service entity 106 may electronically transmit the interactable link to the computing device 102 via a conversation message as part of the digital conversation. In step 320, the receiving device 202 of the computing device 102 may receive the interactable link, which may be presented to the consumer 104 via the display device 218 through the messaging application 212. In step 322, the input device 220 of the computing device 102 may receive input of a user interaction with the interactable link. For example, the consumer 104 may click, touch, or otherwise interact with the interactable link that was displayed to the consumer 104.

Interaction with the link may input the encoded data associated with the proposed electronic payment transaction to the payment application 214. In step 324, the payment application 214 may cause the display device 218 of the computing device 104 to display the proposed electronic payment transaction to the consumer 104 for confirmation thereof. In some embodiments, the confirmation display may include the data encoded in the interactable link. In other embodiments, the payment application 214 may be configured to electronically transmit (e.g., via the transmitting device 222 of the computing device 102) a transaction identifier input via the interactable link to a third party entity for receipt of transaction data therefrom.

In step 326, the input device 220 of the computing device 102 may receive confirmation from the consumer 104 for payment to be made to the service entity 106 for the electronic payment transaction. The confirmation of payment may include the supply or identification of payment credentials associated with a transaction account selected for funding of the payment transaction. As part of the input of confirmation of the transaction account, the transmitting device 222 of the computing device 102 may electronically transmit the confirmation and selected payment credentials to the service entity 106. In step 328, the service entity 106 may receive the payment confirmation. In some embodiments, the service entity 106 may have payment credentials associated with the consumer 104 saved, such as where the service entity 106 may have the payment credentials on file. In step 330, the service entity 106 may initiate the electronic payment transaction using the generated transaction data and the payment credentials supplied by the computing device 102 (e.g., or identified via data provided by the computing device 102). In some instances, the initiation of the electronic payment transaction may include the submission of the transaction data, including payment credentials, to a payment entity 108 or other suitable entity for the generation and submission of a transaction message to the payment network 110 for processing.

### Graphical User Interface

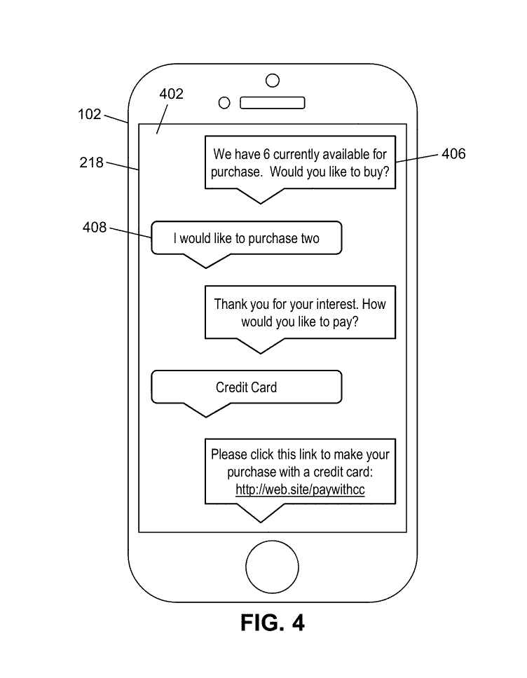

FIG. 4 illustrates an example graphical user interface of the computing device 102 for displaying a digital conversation between the consumer 104 and a representative of the service entity 106 for initiating an electronic payment transaction via an interactable encoded with transaction data. It will be apparent to persons having skill in the relevant art that the interface of the computing device 102 illustrated in FIG. 4 is provided as an illustration only, and that other graphical interfaces may be suitable for performing the functions discussed herein.

The computing device 102 may include a display device 218. The display device 218 may be configured to display a digital conversation 402, such as may be displayed via the messaging application 212 executed by a processor of the computing device 102. The digital conversation may include one or more messages 406 from the representative associated with the service entity 106, and one or more messages submitted by the consumer 104 as a user of the computing device 102 (e.g., via the input device 220).

As illustrated in FIG. 4, the digital conversation 402 may include messages regarding the purchase of a product. As illustrated, the representative indicates that there is a quantity of six items left for a particular product that the consumer 104 is interested in. The consumer 104 indicates a desire to purchase two of the product, after which the representative inquires as to the desired payment method. The consumer 104 then responds that they have a desire to pay for the two products with a credit card. As such, the service entity 106 generates an interactable link that is provided through the digital conversation, where the link directs the computing device 102 to a payment application 214 installed on or otherwise executable by the computing device 102 that is configured to enable the storage, receipt, and transmission of payment credentials for one or more credit cards. The consumer 104 may then interact with the link to be provided with a confirmation screen to confirm the transaction details for the potential electronic payment transaction, upon which the payment transaction may be initiated and processed using traditional methods and systems.

### Exemplary Method for Facilitating Payment Through an Encoded Link

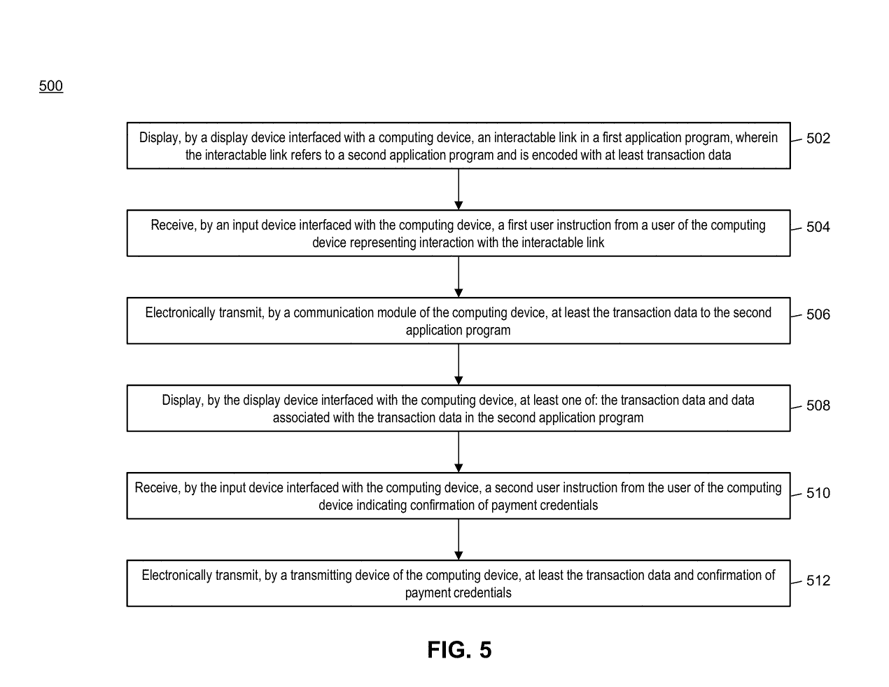

FIG. 5 illustrates a method 500 for the facilitation of payment as part of an electronic payment transaction that is initiated through a link displayed as part of a digital conversation that is encoded with transaction data for a proposed electronic payment transaction or data associated therewith.

In step 502, an interactable link may be displayed by a display device (e.g., the display device 218) interfaced with a computing device (e.g., the computing device 102) in a first application program (e.g., the messaging application 212), wherein the interactable link refers to a second application program (e.g., the payment application 214) and is encoded with at least transaction data. In step 504, a first user instruction may be received by an input device (e.g., the input device 220) of the computing device from a user (e.g., the consumer 104) of the computing device representing interaction with the interactable link.

In step 506, at least the transaction data may be electronically transmitted by a communication module (e.g., the communication module 204) of the computing device to the second application program. In step 508, at least one of the transaction data and data associated therewith may be displayed by the display device interfaced with the computing device in the second application program.

In step 510, a second user instruction may be received by the input device interfaced with the computing device from the user of the computing device indicating confirmation of payment credentials. In step 512, at least the transaction data and confirmation of payment credentials may be electronically transmitted by a transmitting device (e.g., the transmitting device 222) of the computing device.

In one embodiment, the method 500 may further include receiving, by a receiving device (e.g., the receiving device 202) of the computing device, the interactable link from an external computing system (e.g., the service entity 106). In a further embodiment, the transaction data and confirmation of payment credentials may be electronically transmitted to the external computing system. In another further embodiment, the transaction data and confirmation of payment credentials may be electronically transmitted to a third party.

In some embodiments, the first application program and second application program may be a single application program. In a further embodiment, the single application program may include a web browsing application, the interactable link may be displayed in a first web page, and the at least one of: the transaction data and data associated with the transaction data may be displayed in a second web page. In one embodiment, the interactable link may be a uniform resource locator.

In some embodiments, the first application program may include a live messaging application, and the interactable link may be displayed as a live message to the user of the computing device. In a further embodiment, the method 500 may also include electronically transmitting, by the transmitting device of the computing device, at least a request for the interactable link as a live message to an external computing system via the live messaging application, wherein the interactable link is received from the external computing system as a response to the transmitted request. In one embodiment, the second application program may include an electronic wallet application.

### Computer System Architecture

FIG. 6 illustrates a computer system 600 in which embodiments of the present disclosure, or portions thereof, may be implemented as computer-readable code. For example, the computing device 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 5.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device specifically configured to perform the functions discussed herein. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3A, 3B, and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

The processor device 604 may comprise one or more modules or engines configured to perform the functions of the computer system 600. Each of the modules or engines may be implemented using hardware and, in some instances, may also utilize software, such as corresponding to program code and/or programs stored in the main memory 608 or secondary memory 610. In such instances, program code may be compiled by the processor device 604 (e.g., by a compiling module or engine) prior to execution by the hardware of the computer system 600. For example, the program code may be source code written in a programming language that is translated into a lower level language, such as assembly language or machine code, for execution by the processor device 604 and/or any additional hardware components of the computer system 600. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for facilitating payment through an encoded link. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for facilitating payment through an encoded link, comprising:
displaying, by a display device interfaced with a computing device, an interactable link in a first application program, wherein the interactable link refers to a second application program and is encoded with at least transaction data;
receiving, by an input device interfaced with the computing device, a first user instruction from a user of the computing device representing interaction with the interactable link;
electronically transmitting, by a communication module of the computing device, at least the transaction data to the second application program;
displaying, by the display device interfaced with the computing device, at least one of: the transaction data and data associated with the transaction data in the second application program;
receiving, by the input device interfaced with the computing device, a second user instruction from the user of the computing device indicating confirmation of payment credentials; and
electronically transmitting, by a transmitting device of the computing device, at least the transaction data and confirmation of payment credentials.

2. The method of claim 1, further comprising:
receiving, by a receiving device of the computing device, the interactable link from an external computing system.

3. The method of claim 2, wherein the transaction data and confirmation of payment credentials are electronically transmitted to the external computing system.

4. The method of claim 2, wherein the transaction data and confirmation of payment credentials are electronically transmitted to a third party.

5. The method of claim 1, wherein the first application program and second application program are a single application program.

6. The method of claim 6, wherein
the single application program includes a web browsing application,
the interactable link is displayed in a first web page, and
the at least one of: the transaction data and data associated with the transaction data is displayed in a second web page.

7. The method of claim 1, wherein
the first application program includes a live messaging application, and
the interactable link is displayed as a live message to the user of the computing device.

8. The method of claim 7, further comprising:
electronically transmitting, by the transmitting device of the computing device, at least a request for the interactable link as a live message to an external computing system via the live messaging application, wherein
the interactable link is received from the external computing system as a response to the transmitted request.

9. The method of claim 1, wherein the second application program includes an electronic wallet application.

10. The method of claim 1, wherein the interactable link is a uniform resource locator.

11. A system for facilitating payment through an encoded link, comprising:
a transmitting device of a computing device;
a display device interfaced with the computing device configured to display an interactable link in a first application program, wherein the interactable link refers to a second application program and is encoded with at least transaction data;
an input device interfaced with the computing device configured to receive a first user instruction from a user of the computing device representing interaction with the interactable link; and
a communication module of the computing device configured to electronically transmit at least the transaction data to the second application program, wherein
the display device interfaced with the computing device is further configured to display at least one of: the transaction data and data associated with the transaction data in the second application program,
the input device interfaced with the computing device is further configured to receive a second user instruction from the user of the computing device indicating confirmation of payment credentials, and
the transmitting device of the computing device is configured to electronically transmit at least the transaction data and confirmation of payment credentials.

12. The system of claim 11, further comprising:
a receiving device of the computing device configured to receive the interactable link from an external computing system.

13. The system of claim 12, wherein the transaction data and confirmation of payment credentials are electronically transmitted to the external computing system.

14. The system of claim 12, wherein the transaction data and confirmation of payment credentials are electronically transmitted to a third party.

15. The system of claim 11, wherein the first application program and second application program are a single application program.

16. The system of claim 16, wherein
the single application program includes a web browsing application,
the interactable link is displayed in a first web page, and
the at least one of: the transaction data and data associated with the transaction data is displayed in a second web page.

17. The system of claim 11, wherein
the first application program includes a live messaging application, and
the interactable link is displayed as a live message to the user of the computing device.

18. The system of claim 17, wherein
the transmitting device of the computing device is further configured to electronically transmit at least a request for the interactable link as a live message to an external computing system via the live messaging application, and
the interactable link is received from the external computing system as a response to the transmitted request.

19. The system of claim 11, wherein the second application program includes an electronic wallet application.

20. The system of claim 11, wherein the interactable link is a uniform resource locator.
